(19) United States
(12) Patent Application Publication
(10) Pub. No.: US 2005/0246981 A1
(43) Pub. Date: Nov. 10, 2005

(54) Device for, and method of, supporting a glass panel for forming a frameless glass panel fence

(76) Inventor: Wayne Austin, New South Wales (AU)

Correspondence Address: LADAS & PARRY, 26 WEST 61ST STREET, NEW YORK, NY, 10023, US

(21) Appl. No.: 10/512,121

(22) PCT Filed: Apr. 23, 2003
(86) PCT No.: PCT/AU03/00482

§ 371 Date: May 12, 2005

(30) Foreign Application Priority Data
Apr. 23, 2002 (AU) PS 1928

(51) Int. Cl. E06B 3/00

(52) U.S. Cl. 52/208

(57) ABSTRACT

A device for supporting a glass panel (80), the device comprising an anchor member (50) and a mounting member (60) having a first portion (30) and a second portion (62), the first portion (30) being adapted (34) for adjustably mounting the mounting member (60) relative to the anchor member (50), and the second portion (62) being adapted to receive a portion of the glass panel (80), the second portion (62) having a means (14, 24) for locking the glass panel (80) to the mounting member (60).

### FIELD OF THE INVENTION

The present invention relates to a device for, and method of, supporting a glass panel for forming a frameless glass panel fence, such as for swimming pools, balconies and the like.

### BACKGROUND OF THE INVENTION

Known frameless glass panel fences are installed by what are known as “inground” methods. One such method includes forming a base of concrete for the fence with a 50 mm wide×100 mm deep channel extending therethrough. Compressed rubber blocks are inserted into the channels and the glass panels are then inserted into the channels to rest on the rubber blocks. Each panel is then aligned with other panels and fixed in position temporarily by wedges and the like in the channel. Epoxy grout is then poured into the channel and left for a few days to set hard to fix the glass panels in position.

The above method has a number of disadvantages. Firstly, in order to align the glass panels to the correct height, the concrete channel must be formed substantially level which is difficult. Whilst adjustment of each glass panel height may be performed by adding/removing rubber blocks, this requires realignment and temporary fixing of the panels. These steps are labour intensive, costly and requires considerable skill. The pouring of grout is also labour intensive, costly and requires a substantial amount of the grouting material. Accurate alignment of the glass panels is also difficult as glass panels are rarely true.

The above inground method also requires the concrete base to be thickened by up to 100 mm on each side of the panels requiring expensive additional building materials such as reinforcing steel and concrete.

The inground method also usually requires the ground on each side of the panel to be tiled up to 6 mm away from the glass panel. A flexible jointing compound is then used on each side of the panels to allow for expansion and contraction of the panels. Paving adjacent the glass panel fence also has to be sloped away from the fence as it may allow moisture to be retained adjacent to the fence and cause undesired discolouration of the jointing compound and tiles.

Another known method uses a 170 mm high×50 mm wide clamp which has a slot for receiving the glass panel. The slot includes a single attachment hole, which is aligned with a corresponding hole in the glass panel. A bolt is inserted into the aligned holes to fix the glass panel to the clamp. Three such clamps are typically used for each panel. Holes for receiving the clamps are drilled into a concrete slab ground or footing. The clamps are then inserted into the holes, temporary fixed in position, and grouted into position.

The above clamp method has time and cost advantages over the inground method. However, the clamp method still requires the clamps to be temporary fixed, which is labour intensive. Further, height and lateral adjustment of the glass panels cannot be performed with the clamp method. Support for the glass panel is dependent on the amount of the clamp embedded into the ground. With the clamp being typically 170 mm high, 100 mm of the clamp is typically embedded in the ground, leaving only 70 mm of support above ground level. Further, a gap of about 30 mm is usually formed between the glass panel and ground when installing, meaning only 40 mm of the clamp material is actually supporting the glass panel. This does not result in a very strong installation.

It is the object of the present invention to substantially overcome or at least ameliorate one or more of the prior art disadvantages.

### SUMMARY OF THE INVENTION

The present invention provides a device for supporting a glass panel, the device comprising:

an anchor member; and

a mounting member having a first portion and a second portion, the first portion being adapted for adjustably mounting the mounting member relative to the anchor member, and the second portion being adapted to receive a portion of the glass panel, the second portion having a means for locking the glass panel to the mounting member.

In a preferred embodiment, the anchor member has an elongated portion and a base. In the preferred embodiment, the mounting member first portion is adapted to receive the anchor member elongated portion for adjustably mounting the mounting member relative to the anchor member. Preferably, the anchor member elongated portion is threaded. The mounting member first portion preferably includes a correspondingly threaded portion for engagement with the anchor member threaded portion.

Preferably, the second portion is a slot formed in the mounting member. Preferably, the slot is formed between two side sections of the mounting member attached to opposite sides of a middle section. The two side sections preferably each include at least one mounting hole through which an attachment member may pass. A corresponding hole may then be formed in the glass panel. An attachment member, eg. a bolt, may then be inserted through the aligned holes in the side sections and the glass panel to lock the glass panel in position to the mounting member. The glass panel preferably rests on the middle section when inserted in the slot. The mounting hole in one of the side sections is preferably threaded. The mounting hole in the other side section is preferably countersunk to receive the head of the attachment bolt. Preferably, at least two spaced corresponding holes are formed in the side sections.

Preferably, the side sections are bolted to the middle section. The middle section preferably includes a threaded bore for receiving the anchor member threaded portion.

Preferably, the slot has a width greater than the width of the glass panel to be supported.

In another aspect, the present invention provides a method for supporting a glass panel to the ground using the above device, the method comprising

drilling a hole into the ground;

inserting an anchor member into the drilled hole and fixing the anchor member in position;

mounting the mounting member first portion to the anchor member;

placing the glass panel into the mounting member second portion; and

fixing the glass panel to the mounting member via the locking means.

Preferably, the step of mounting the mounting member to the anchor member further includes the step of adjusting the position of the mounting member relative to the anchor member.

Preferably, the step of placing the glass panel to the mounting member further includes the step of adjusting the position of the glass panel relative to the mounting member.

Preferably, at least two of the devices are used to support each glass panel.

### DESCRIPTION OF THE DRAWINGS

A preferred form of the present invention will now be described by way of example only with reference to the accompanying drawings wherein:

FIGS. 1a to 1c show (a) elevation, (b) side and (c) bottom end views of a first side section of a mounting member of a preferred embodiment of the present invention;

FIGS. 2a to 2c show (a) elevation, (b) side and (c) bottom end views of a second side section of the mounting member of the preferred embodiment;

FIGS. 3a to 3c show (a) elevation, (b) side and (c) bottom end views of a middle section of the mounting member of the preferred embodiment;

FIG. 4 is an elevation view of an anchor member in accordance with the preferred embodiment;

FIG. 5 is an elevation view of an assembled mounting member of the preferred embodiment; and

FIG. 6 is a perspective view of the preferred embodiment in use.

### DETAILED DESCRIPTION OF THE PREFERRED EMBODIMENT

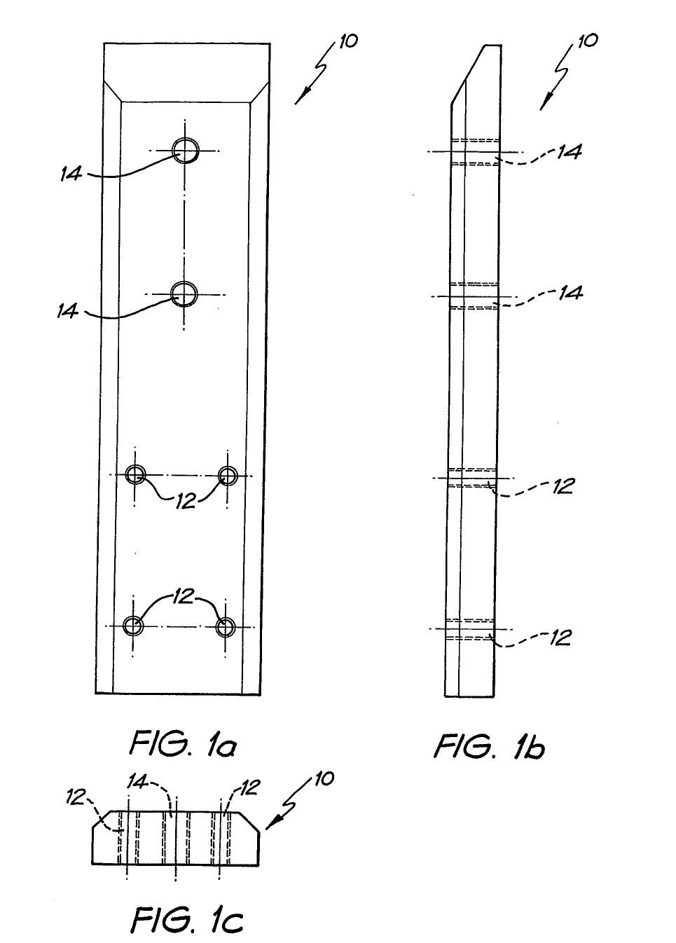

FIGS. 1a to 1c show a first elongated side section 10 of a mounting member according to a preferred embodiment of the present invention. The side section 10 includes four first mounting holes 12 and two second mounting holes 14. The mounting holes 12 and 14 are all threaded, and their function will be explained below.

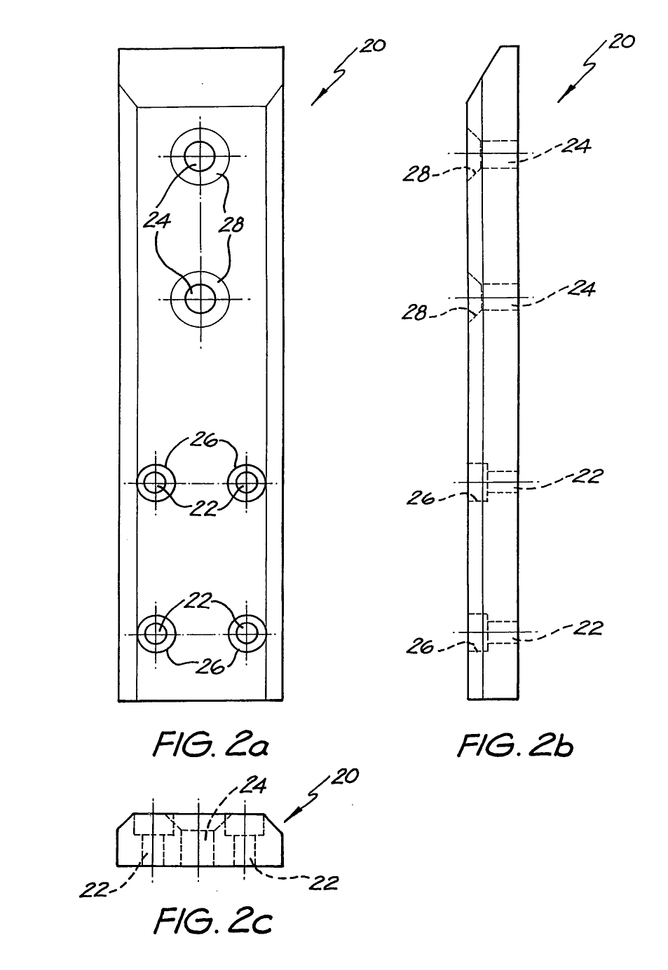

FIGS. 2a to 2c show a second elongated side section 20 of the mounting member of the preferred embodiment. The side section 20 is similarly shaped and dimensioned as the side section 10 and includes four first mounting holes 22 and two second mounting holes 24. The mounting holes 22 and 24 are all countersunk at 26 and 28, respectively, and their function will be explained below.

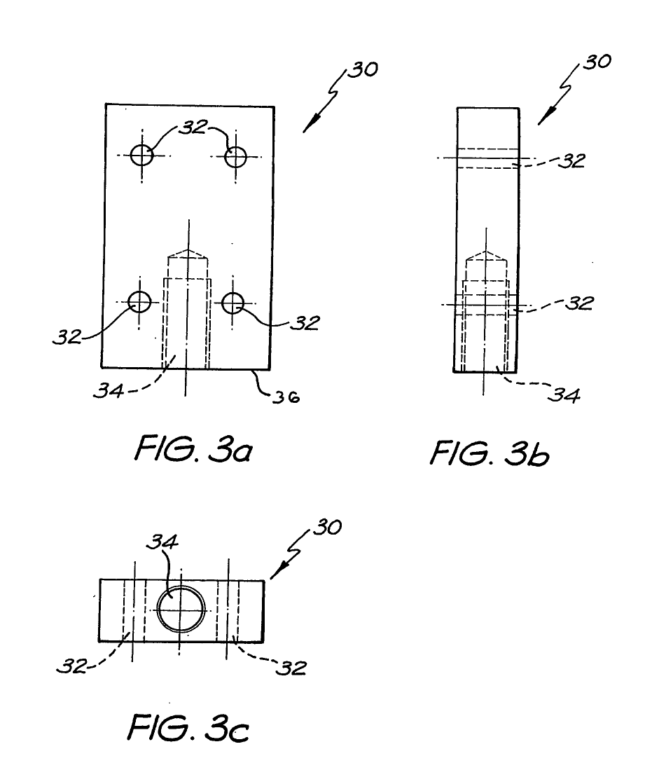

FIGS. 3a to 3c show a middle section 30 of the mounting member of the preferred embodiment. The middle section 30 includes four mounting holes 32 and a threaded bore 34 extending from a bottom surface 36 thereof. The function of the mounting holes 32 and threaded bore 34 will be explained below.

FIG. 4 shows an anchor member 50 of the preferred embodiment. The anchor member 50 includes a threaded elongated portion 52 and a base 54. The threaded portion 52 of the anchor member 50 is typically 16 mm in diameter and 50 to 150 mm long. The anchor member 50 is formed by an M16 threaded bar with preferably an end being bent to provide the base 54.

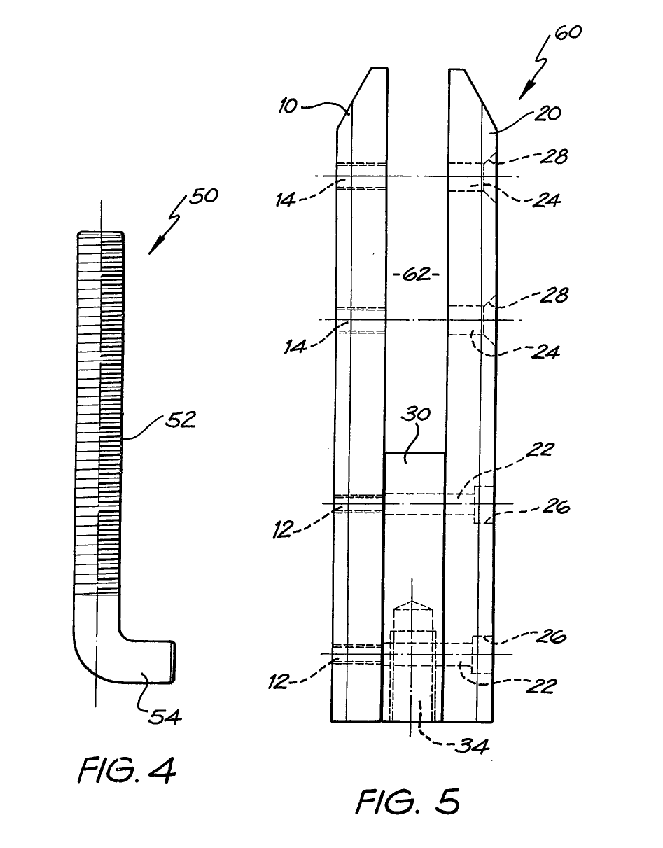

FIG. 5 shows an assembled mounting member 60 of the preferred embodiment. The two side sections 10, 20 of the mounting member are attached to opposite sides of the middle section 30 by aligning the mounting holes 12, 22 and 32 and inserting bolts (not shown) through the aligned holes. The bolts are threaded into the mounting holes 12 and heads of the bolts are received by the countersinks 26. When assembled, a slot 62 is formed between the side sections 10 and 20. The slot 62 has a width greater than the width of the glass panel to be supported. When assembled, the threaded bore 34 extends downwardly. The mounting member 60 is typically 215 mm high.

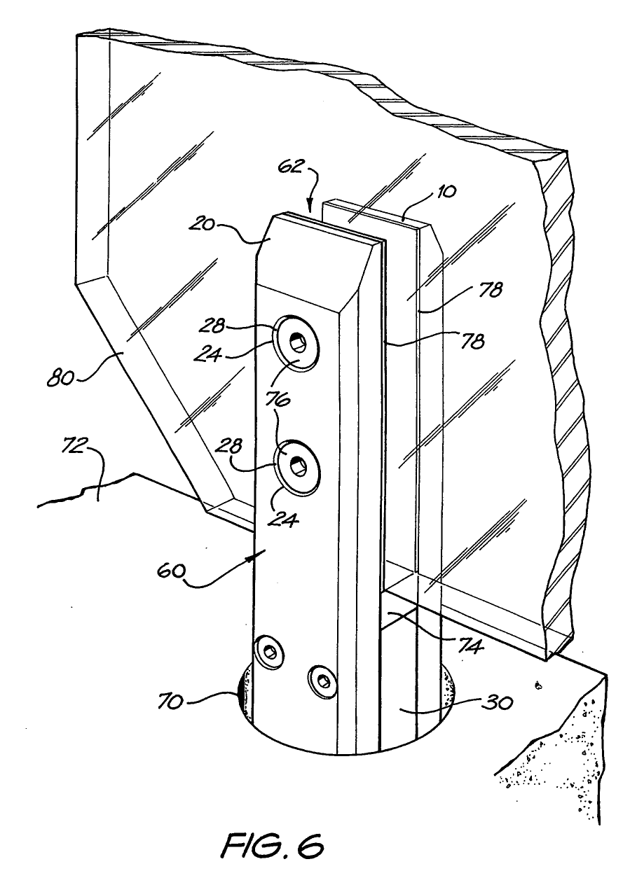

The method of supporting a glass panel using the mounting member 60 and anchor member 50 will now be described with reference to FIG. 6.

Firstly, a hole 70 is drilled into a concrete slab ground or footing 72. The hole 70 has a diameter (typically 83 mm) greater than the width and thickness dimensions of the mounting member 60 and is typically 50 to 150 mm deep. The anchor member 50 is then inserted into the hole 70 with the threaded portion 52 extending upwardly. The base 54 is fixed in position with the threaded portion 52 vertical using a high strength epoxy compound.

The threaded bore 34 of the mounting member 60 is then engaged with the threaded portion 52 of the anchor member 50 and rotated to a predetermined height relative to the ground. The threaded portion 52 and bore 34 allows for height adjustable mounting of the mounting member 60 to the anchor member 50. Lower portions of the mounting member 60 are inserted into the drilled hole 70, typically 10 to 60 mm below the ground level.

An 8 mm high compressed plastic block 74 is inserted into the slot 62 to rest on the upper surface of the middle section 30. A glass panel 80 having two attachment holes (not shown) is then inserted into the slot 62 and positioned such that its attachment holes align with the second mounting holes 14, 24 of the side sections 10, 20. The glass panel 80 preferably rests on the plastic block 74 when inserted in the slot 62. Bolts 76 are inserted through the aligned mounting holes 14, 24 and glass panel holes to lock the glass panel 80 to the mounting member 60. The bolts 76 are threaded into the mounting holes 14 and heads of the bolts are received by the countersinks 28.

The height of the glass panel 80 can be adjusted by steps of 2 mm if required by rotating the mounting member 60 relative to the anchor member 50. Finer height adjustment of the glass panel 80 can be performed by adding to or reducing the thickness of the plastic block 74. The gaps between the glass panel and the side sections 10, 20 is filled with compressed polypropylene packers 78 of between 0.8 and 3 mm thick which allows the glass panels 80 to be accurately positioned laterally to create a substantially straight line with other panels 80. At least two spaced pairs of anchor members 50 and mounting members 60 are used with each glass panel 80.

After panel alignment and height adjustments are completed, each drilled ground hole 70 is filled to almost ground level with epoxy compound to lock the anchor members 50 and mounting members 60 in position. The holes 70 are then topped to ground level with a grout to match the concrete ground or footing 72.

The preferred embodiment described above has a number of advantages over the existing methods. For example, in the preferred embodiment, the positioning and levelling of the glass panels 80 is performed while inserting and bolting same to the mounting member 60. Accordingly, this obviates the need to temporary fix the glass panel in position for pouring of the epoxy. Thus, there is less chance for the glass panel to fall over or move.

The preferred embodiment allows a number of adjustments to be performed to allow for different installation site variables and the variables inherent in glass production. The height of the mounting member 60 from the ground can be adjusted by up to 20 mm after the anchor member 50 has already been fixed to the ground hole. Also, the mounting member 60 allows for the glass panel to be moved laterally toward and away from the side sections 10, 20 by up to 4 mm in each side by varying the thickness of the compressed polypropylene packers 78, providing a substantial amount of adjustment for the glass panel

The preferred embodiment provides better support than existing inground systems which means that even for 1200 mm height glass panels, the panels are supported more rigidly. The strength of the support provided by the preferred embodiment allows for a gate for the fence to be fixed hingedly to one of the glass panels without the need for additional support posts.

With the currently used epoxy compound and as temporary fixing of the glass panel is not required, installation of the glass panels can be performed in 1 day, although 2 days are preferable.

The mounting of the glass panels to the preferred embodiment above also involves less contact with the glass panels compared to the inground method. This allows the preferred embodiment to cater for expansion and contraction of the glass panels. Thus, using the preferred embodiment, glass sheets of up to 3600 mm long can be used compared to maximum sheet sizes of 2000 mm for the inground method.

Compared to the existing clamp method described above, the preferred embodiment provides height and lateral adjustment of the glass panels. Further, support for the glass panel is not dependent on the amount of the mounting member embedded into the ground. The preferred embodiment allows for a minimum of 120 mm of the mounting member material to hold the glass and a variable gap of 30 to 75 mm to be formed between the glass panel and ground.

The present invention has been described in relation to supporting a glass panel. It is to be understood however that the present invention can also be used for supporting panels made from materials other than glass.

Although a preferred embodiment of the present invention has been described, it will be apparent to persons skilled in the art that the invention may be embodied in other forms or that modifications can be made to the above embodiments.

1. A device for supporting a glass panel, the glass panel having at least one mounting hole at a bottom portion thereof, the device comprising:
an anchor member; and
a mounting member having a first portion and a second portion, the first portion being adapted for adjustably mounting the mounting member relative to the anchor member, and the second portion being adapted to receive a portion of the glass panel, the second portion having a means for locking the glass panel to the mounting member via the glass panel mounting hole(s).

2. The device of claim 1 wherein the mounting member locking means includes at least one mounting hole formed in the second portion, wherein in use, an attachment member can be inserted through aligned glass panel and mounting member mounting holes for locking the glass panel to the mounting member.

3. The device of claim 2 wherein the mounting member includes two spaced mounting holes for supporting a glass panel having two spaced mounting holes at a bottom portion thereof.

4. The device of claim 3 wherein the mounting member two mounting holes are arranged to be spaced vertically from each other in use.

5. The device of claim 1 wherein the second portion is a slot formed in the mounting member.

6. The device of claim 5 wherein the second portion includes a pair of mounting holes formed on opposite sides of the slot for each glass panel mounting hole.

7. The device of claim 6 wherein the mounting hole(s) in one side of the slot is threaded to receive a threaded shank of an attachment member.

8. The device of claim 7 wherein the mounting hole(s) in the other side of the slot is countersunk to receive a head of the attachment member.

9. The device of claim 5 wherein the slot has a width greater than the width of the glass panel to be supported.

10. The device of claim 5 wherein the slot is formed between two side sections of the mounting member which are attached to opposite sides of a middle section of the mounting member.

11. The device of claim 10 wherein the middle section includes a threaded bore for receiving a threaded portion of the anchor member.

12. The device of claim 10 wherein the anchor member has an elongated portion and a base.

13. The device of claim 12 wherein the mounting member first portion is adapted to receive the anchor member elongated portion for adjustably mounting the mounting member relative to the anchor member.

14. The device of claim 12 wherein the anchor member elongated portion is threaded.

15. A method for supporting a glass panel to the ground using the device of claim 1, the glass panel having at least one mounting hole at a bottom portion thereof, the method comprising:
drilling a hole into the ground;
inserting the anchor member into the drilled hole and fixing the anchor member in position;
mounting the mounting member first portion to the anchor member;
placing a portion of the glass panel into the mounting member second portion; and
locking the glass panel to the mounting member via the glass panel mounting hole(s).

16. The method of claim 15, wherein the mounting member locking means includes at least one mounting hole, and wherein the step of locking the glass panel to the mounting member includes inserting an attachment member through the glass panel and mounting member mounting holes to lock the glass panel to the mounting member.

17. The method of claim 15 wherein the step of mounting the mounting member to the anchor member further includes the step of adjusting the position of the mounting member relative to the anchor member.

18. The method of claim 15, wherein the step of placing the glass panel into the mounting member further includes the step of adjusting the position of the glass panel relative to the mounting member.

19. The method of claim 15 wherein at least two of the devices are used to support each glass panel.

20. The method of claim 16 wherein the glass panel includes two vertically spaced mounting holes, the mounting member second portion is a slot formed in the mounting member, and the second portion includes a pair of mounting holes formed on opposite sides of the slot for each glass panel mounting hole,
wherein the step of locking the glass panel to the mounting member includes the step of inserting a respective attachment member through each aligned corresponding holes of the mounting member and the glass panel.

21. A glass panel fence having the support device of claim 1, and a glass panel having at least one mounting hole at a bottom portion thereof mounted to the device.

22. The glass panel fence of claim 22 having two support devices supporting each glass panel.
